(19) United States
(12) Patent Application Publication
(10) Pub. No.: US 2025/0168890 A1
(43) Pub. Date: May 22, 2025

(54) METHODS, DEVICES, AND COMPUTER READABLE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 18/833,718

(22) PCT Filed: Jan. 27, 2022
(86) PCT No.: PCT/CN2022/074433

§ 371 Date: Jul. 26, 2024

(51) Int. Cl. H04W 74/0833; H04W 56/00; H04W 76/38

(52) U.S. Cl. CPC H04W 74/0833; H04W 56/0015; H04W 76/38

(57) ABSTRACT

Embodiments of the present disclosure relate to methods, devices, and computer readable medium for communication. According to embodiments of the present disclosure, a first network device receives a plurality of SSB signals from a second network device in a plurality of periods. The first network device transmits the plurality of SSB signals by a first network device via a plurality of first beams towards respective directions. A first beam for transmitting the plurality of SSB signals is changed per period, and random access resources correspond to the plurality of SSB signals being associated with the plurality of periods. The first network device receives, from a terminal device, a random access signal on one of the random access resources associated with a corresponding one of the plurality of periods. The first network device transmits the random access signal to the second network device. In this way, the beam determination procedure for the link between the repeater and the UE can be facilitated.

### TECHNICAL FIELD

Embodiments of the present disclosure generally relate to the field of telecommunication, and in particular, to methods, devices, and computer readable medium for communication.

### BACKGROUND

Radio frequency (RF) repeater has been widely deployed in 2G, 3G and 4G networks to facilitate the communications between base stations and UEs. The RF repeaters can supplement or extend the network coverage by simply amplifying and forwarding the received signal via omnidirectional beams or directional beams. Hence, the deployment and application of repeaters in the network is cost efficient. On the other hand, since the repeaters are unable to take into account various factors that could improve system performance. Such factors may include information on semi-static and/or dynamic downlink (DL)/uplink (UL) configuration, adaptive transmitter/receiver spatial beamforming, ON-OFF status, etc.

A network-controlled repeater has been proposed as an enhancement over conventional RF repeaters with the capability to receive and process side control information from the network. Side control information allows the network-controlled repeater to perform amplify-and-forward operations in a more efficient manner. Potential benefits could include mitigation of unnecessary noise amplification, transmissions (Tx) and receptions (Rx) with better spatial directivity, simplified network integration and so on. Therefore, it would be worth studying a beam determination procedure of repeater.

### SUMMARY

In general, example embodiments of the present disclosure provide a solution for communication.

In a first aspect, there is provided a method for communication. The communication method comprises: upon receipt of a plurality of SSB signals from a second network device in a plurality of periods, transmitting the plurality of SSB signals by a first network device via a plurality of first beams, a first beam for transmitting the plurality of SSB signals being changed per period, and random access resources corresponding to the plurality of SSB signals being associated with the plurality of periods; receiving, from a terminal device, a random access signal on one of the random access resources associated with a corresponding one of the plurality of periods; and transmitting the random access signal to the second network device.

In a second aspect, there is provided a method for communication. The communication method comprises: transmitting, at a second network device and to a first network device, a plurality of SSB signals in a plurality of periods, the plurality of SSB signals to be transmitted by the second network device via a plurality of first beams, a first beam for transmitting the plurality of SSB signals being changed per period; receiving, from the first network device, a random access signal transmitted by a terminal device on random access resources, wherein random access resources corresponding to the plurality of SSB signals are associated with the plurality of periods; determining at least one target beam from the plurality of first beams based on the association of the random access resources and the plurality of periods; and transmitting, to the first network device, beam information indicative of the at least one target beam for communication between the first network device and the terminal device.

In a third aspect, there is provided a method for communication. The communication method comprises: receiving, at a terminal device and from a first network device, a plurality of SSB signals in a plurality of periods, the plurality of SSB signals being originally transmitted by a second network device and then transmitted by the first network device via a plurality of first beams, a first beam for transmitting the plurality of SSB signals being changed per period; determining one of the random access resources for a random access signal based on a measurement result of the plurality of SSB signals and the association of the random access resources and the plurality of periods; and transmitting the random access signal to the first network device on the random access resource, the random access signal to be transmitted by first network device to second network device.

In a fourth aspect, there is provided a method for communication. The communication method comprises: receiving, at a first network device, a plurality of SSB signals transmitted via a first beam of a second network device, the plurality of SSB signals being associated with a plurality of second beams of the second network device, random access resources associated with the plurality of SSB signals corresponding to the first beam, and preambles associated with the plurality of SSB signals being different from a preamble corresponding to the first beam; storing the plurality of SSB signals at the first network device; transmitting the plurality of SSB signals via a plurality of beams of the first network device in a beam sweeping manner; receiving, from a terminal device, a random access signal with a preamble associated with one of the plurality of SSB signals on the random access resources; and transmitting the random access signal to the second network device for determining at least one target beam from the plurality of beams.

In a fifth aspect, there is provided a method for communication. The communication method comprises: transmitting, at a second network device and to a first network device, a plurality of SSB signals via a first beam of a second network device, the plurality of SSB signals being associated with a plurality of second beams of the second network device, random access resources associated with the plurality of SSB signals corresponding to the first beam, and preambles associated with the plurality of SSB signals being different from a preamble corresponding to the first beam; receiving, from the first network device, a random access signal with a preamble associated with one of the plurality of SSB signals on the random access resources; determining at least one target beam from a plurality of beams of the first network device based on the preamble; and transmitting, to the first network device, beam information indicative of the at least one target beam for communication between the first network device and the terminal device.

In a sixth aspect, there is provided a first network device. The first network device comprises a processing unit; and a memory coupled to the processing unit and storing instructions thereon, the instructions, when executed by the processing unit, causing the first network device to perform acts comprising: upon receipt of a plurality of SSB signals from a second network device in a plurality of periods, transmitting the plurality of SSB signals by a first network device via a plurality of first beams, a first beam for transmitting the plurality of SSB signals being changed per period, and random access resources corresponding to the plurality of SSB signals being associated with the plurality of periods; and receiving, from a terminal device, a random access signal on one of the random access resources associated with a corresponding one of the plurality of periods; and transmitting the random access signal to the second network device.

In a seventh aspect, there is provided a second network device. The second network device comprises a processing unit; and a memory coupled to the processing unit and storing instructions thereon, the instructions, when executed by the processing unit, causing the second network device to perform acts comprising: transmitting, at a second network device and to a second network device, a plurality of SSB signals in a plurality of periods, the plurality of SSB signals to be transmitted by the second network device via a plurality of first beams, a first beam for transmitting the plurality of SSB signals being changed per period; receiving, from the first network device, a random access signal transmitted by a terminal device on random access resources, wherein random access resources corresponding to the plurality of SSB signals are associated with the plurality of periods; determining at least one target beam from the plurality of first beams based on the association of the random access resources and the plurality of periods; and transmitting, to the first network device, beam information indicative of the at least one target beam for communication between the first network device and the terminal device.

In an eighth aspect, there is provided a terminal device. The terminal device comprises a processing unit; and a memory coupled to the processing unit and storing instructions thereon, the instructions, when executed by the processing unit, causing the terminal device to perform acts comprising: receiving, at a terminal device and from a first network device, a plurality of SSB signals in a plurality of periods, the plurality of SSB signals being originally transmitted by a second network device and then transmitted by the first network device via a plurality of first beams, a first beam for transmitting the plurality of SSB signals being changed per period; determining one of the random access resources for a random access signal based on a measurement result of the plurality of SSB signals and the association of the random access resources and the plurality of periods; and transmitting the random access signal to the first network device on the random access resource, the random access signal to be transmitted by first network device to second network device.

In a ninth aspect, there is provided a first network device. The first network device comprises a processing unit; and a memory coupled to the processing unit and storing instructions thereon, the instructions, when executed by the processing unit, causing the first network device to perform acts comprising: receiving, at a first network device, a plurality of SSB signals transmitted via a first beam of a second network device, the plurality of SSB signals being associated with a plurality of second beams of the second network device, random access resources associated with the plurality of SSB signals corresponding to the first beam, and preambles associated with the plurality of SSB signals being different from a preamble corresponding to the first beam; storing the plurality of SSB signals at the first network device; transmitting the plurality of SSB signals via a plurality of beams of the first network device in a beam sweeping manner; receiving, from a terminal device, a random access signal with a preamble associated with one of the plurality of SSB signals on the random access resources; and transmitting the random access signal to the second network device for determining at least one target beam from the plurality of beams.

In a tenth aspect, there is provided a second network device. The second network device comprises a processing unit; and a memory coupled to the processing unit and storing instructions thereon, the instructions, when executed by the processing unit, causing the second network device to perform acts comprising: transmitting, at a second network device and to a first network device, a plurality of SSB signals via a first beam of a second network device, the plurality of SSB signals being associated with a plurality of second beams of the second network device, random access resources associated with the plurality of SSB signals corresponding to the first beam, and preambles associated with the plurality of SSB signals being different from a preamble corresponding to the first beam; receiving, from the first network device, a random access signal with a preamble associated with one of the plurality of SSB signals on the random access resources; determining at least one target beam from a plurality of beams of the first network device based on the preamble; and transmitting, to the first network device, beam information indicative of the at least one target beam for communication between the first network device and the terminal device.

In an eleventh aspect, there is provided a computer readable medium having instructions stored thereon, the instructions, when executed on at least one processor, causing the at least one processor to carry out the method according to any of the first to fifth aspects.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3 illustrates a schematic diagram of an example SSB transmission scheme according to some embodiments of the present disclosure;

FIG. 4A illustrates a schematic diagram of an example scheme of PRACH resource determination according to some embodiments of the present disclosure;

FIG. 4B illustrates a schematic diagram of another example scheme of PRACH resource determination according to some embodiments of the present disclosure;

FIG. 5 illustrates a signaling flow for communications according to some embodiments of the present disclosure;

FIG. 6A illustrates a schematic diagram of an example beam configuration according to some embodiments of the present disclosure;

FIG. 6B illustrates an example SSB transmission scheme according to some embodiments of the present disclosure;

FIG. 7 is a flowchart of an example method for communication in accordance with an embodiment of the present disclosure;

FIG. 8 is a flowchart of an example method for communication in accordance with an embodiment of the present disclosure

FIG. 9 is a flowchart of an example method for communication in accordance with an embodiment of the present disclosure;

FIG. 10 is a flowchart of an example method for communication in accordance with an embodiment of the present disclosure;

FIG. 11 is a flowchart of an example method for communication in accordance with an embodiment of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further have ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (410 MHZ-7125 MHZ), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

Network coverage is a fundamental aspect of cellular network deployments. Mobile operators rely on different types of network nodes to offer blanket coverage in their deployments. Deployment of regular full-stack cells is one option but it may not be always possible (e.g., no availability of backhaul) or economically viable.

As a result, new types of network nodes have been considered to increase mobile operators' flexibility for their network deployments. For example, Integrated Access and Backhaul (IAB) was introduced in Rel-16 and enhanced in Rel-17 as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells. In Rel-17, RAN4 specified RF and EMC requirements for such RF repeaters for NR targeting both FR1 and FR2.

While an RF repeater presents a cost-effective means of extending network coverage, it has its limitations. The RF repeater simply performs amplify-and-forward operations without capability of taking into account various factors that could improve network performance. Such factors may include information on semi-static and/or dynamic DL/UL configuration, adaptive transmitter/receiver spatial beamforming, ON-OFF status, etc.

As previously discussed, a network-controlled repeater is an enhancement over conventional RF repeaters with the capability to receive and process side control information from the network. Side control information is introduced for beam management at the RF repeater side. The side control information may include, but not limited to, beamforming information, timing information to align transmission (Tx)/reception (Rx) boundaries of network-controlled repeater, information on uplink to UL-DL TDD (uplink-downlink time division duplex) configuration, ON-OFF information for efficient interference management and improved energy efficiency, power control information for efficient interference management, etc.

It is desirable to determine the best beam pair of repeater for a link between the repeater and the UE, especially during an initial access procedure. However, currently it is not clear how to implement the beam pair determination in the initial access procedure. Moreover, it is expected that the beam determination procedure would not introduce a large delay.

In order to solve above problems or other potential problems, solutions on beam determination of repeater are proposed. According to embodiments of the present disclosure, PRACH (physical random access channel) resources are associated with system frame number (SFN). The repeater changes the beam direction for transmitting synchronization signal/physical broadcast channel block (SSB) signal circularly. Upon detecting the SSB signal, the UE can determine the PRACH resource by considering the SFN, and transmit the random access signal on the determined PRACH resource. In this way, the gNB is able to determine the best beam of repeater for the link between repeater and UE based on the association of PRACH resource and SFN, and indicate the beam information to the repeater.

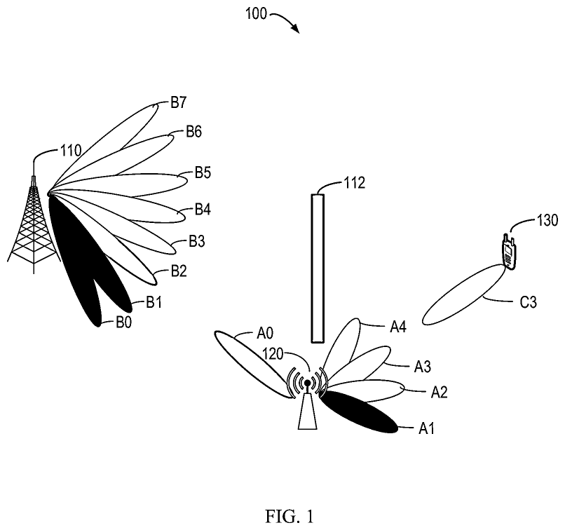

FIG. 1 illustrates a schematic diagram of a communication system in which embodiments of the present disclosure can be implemented. The communication system 100, which is a part of a communication network, includes a first network device 120, a second network device 110 and a terminal device 130. The first network device 120 may be a network-controlled RF repeater, which may be also referred to as “the repeater 120” hereinafter. The second network device 110 may be a base station, which may be also referred to as “the base station 110” or “the gNB 110”. The terminal device 130 may be a UE, which may be also referred to as “the UE 130”.

In the communication system 100, due to the presence of block 112 or a long distance, the gNB 110 and the UE 130 may communicate data and control information to each other by means of amplify-and-forward operations of the repeater 120. Each of the gNB 110, the repeater 120, and the UE 130 may utilize one or more beams towards respective directions for UL/DL transmissions. As shown in FIG. 1, the gNB 110 may utilize beams B0 to B7, the repeater may utilize beams A0 to A4, and the UE 130 may utilize at least beam C3.

In the context of the example embodiments, the direction from the gNB 110 to the repeater 120 and the direction from the network (which includes the gNB 110 and the repeater 120) to the UE 130 refers to downlink or DL. The direction from the repeater 120 to the gNB 110 and the direction of the UE 130 to the network refers to uplink or UL.

It should be understood that the numbers of network devices and terminal devices as well as the beam number and beam directions shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

A UE realizes time and frequency synchronization with the network based on synchronization signal (SS). In 5G NR, SS is bound to physical broadcast channel (PBCH) to form SS/PBCH block. Furthermore, the UE determines PRACH resources/occasions based on detected SS/PBCH block. SS/PBCH block indexes associated with DMRS sequence of PBCH and indicated by MIB (master information block) are mapped to valid PRACH occasions in the following order:
First, in increasing order of preamble indexes within a single PRACH occasion;
Second, in increasing order of frequency resource indexes for frequency multiplexed PRACH occasions;
Third, in increasing order of time resource indexes for time multiplexed PRACH occasions within a PRACH slot;
Fourth, in increasing order of indexes for PRACH slots.

Table 1 shows mapping between the PRACH configuration period and SS/PBCH block to PRACH occasion association period.

TABLE 1
Mapping between PRACH configuration period and SS/PBCH
block to PRACH occasion association period

| PRACH configuration | Association period (number of PRACH |
|---|---|
| period (msec) | configuration periods) |
| 10 | {1, 2, 4, 8, 16} |
| 20 | {1, 2, 4, 8} |
| 40 | {1, 2, 4} |
| 80 | {1, 2} |
| 160 | {1} |

The pattern of SS/PBCH blocks in the first half frame is decided by SCS, and carrier frequency. For a half frame with SS/PBCH blocks, the first symbol indexed for candidate SS/PBCH blocks are determined according to the SCS of SS/PBCH blocks as follows, where index 0 corresponds to the first symbol of the first slot in a half-frame. Taking SCS equals to 15 kHz and 120 kHz as examples, the first symbols are shown as follow:

Case A-15 kHz SCS: the first symbols of the candidate SS/PBCH blocks have indexes of {2, 8}+14·n.

For operation without shared spectrum channel access:
For carrier frequencies smaller than or equal to 3 GHZ, n=0,1.
For carrier frequencies within FR1 larger than 3 GHZ, n=0, 1, 2, 3.
For operation with shared spectrum channel access, n=0, 1, 2, 3, 4.

Case D-120 kHz SCS: the first symbols of the candidate SS/PBCH blocks have indexes {4, 8, 16, 20}+28·n.

For carrier frequencies within FR2, n=0, 1, 2, 3, 5, 6, 7, 8, 10, 11, 12, 13, 15, 16, 17, 18.

Embodiments of the present disclosure will be described in detail below.

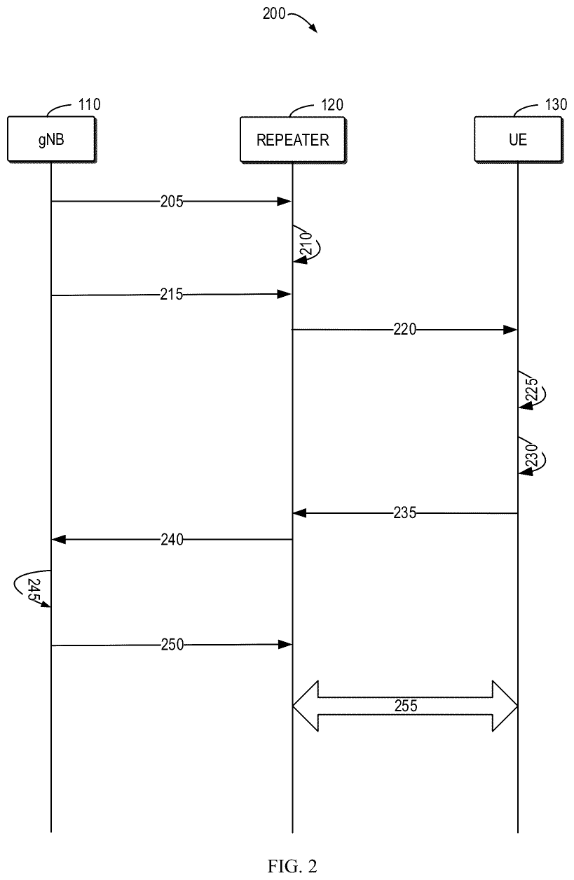

Reference is first made to FIG. 2, which shows a signaling chart for a communication process 200 among the gNB 110, the repeater 120, and the UE 130 according to some example embodiments of the present disclosure. Only for the purpose of discussion, the process 200 will be described with reference to FIG. 1.

In the process 200, the SSB transmission is periodically. The gNB 110 may broadcast SIB1 in the network coverage. Upon receipt of the SIB1, the repeater 120 may establish RRC connection with the repeater 120, and the periodicity of SSB is informed by the gNB 110 via RRC signaling. Alternatively, the gNB 110 may inform the repeater 120 of the periodicity via side control channel directly.

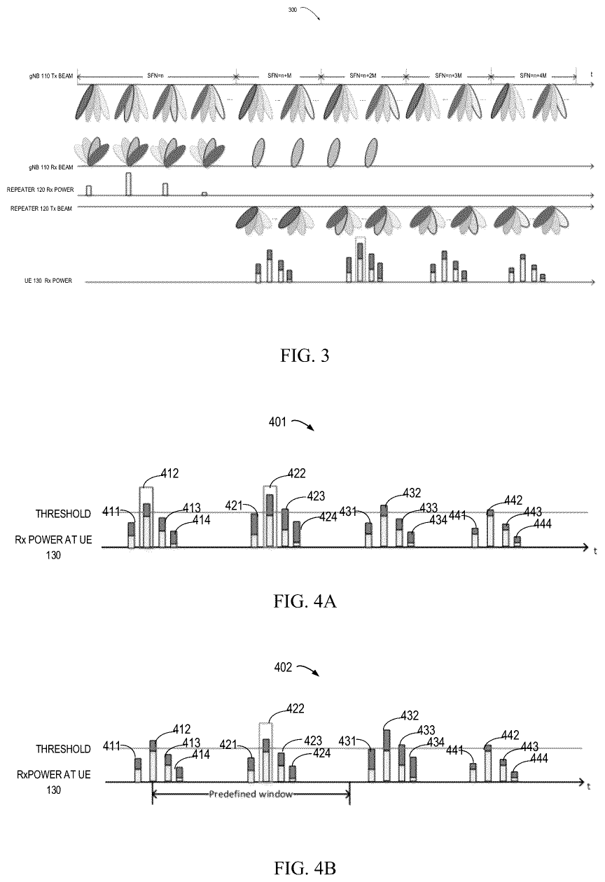

The gNB 110 transmits 205 SSB signals based on the indicated periodicity. In the following descriptions, the process 300 will be described in connection with FIG. 3, which illustrates an example SSB transmission scheme 300 according to some embodiments of the present disclosure.

The repeater 120 performs 210 the blind detection for the SSB signals, and decodes system information. As shown in FIG. 3, the repeater 120 may measure the received signal power of the SSB signals, and for each period, the repeater 120 utilizes the same beam for receiving the SSB signals. For example, the SSB signals may be measured with a minimum periodicity, such as, 0.5 ms.

The repeater 120 may then determine Rx beam for DL transmission and Tx beam for UL transmission related to the gNB 110. For example, the Tx/Rx beam may be determined to be beam A0 as shown in FIG. 1.

Accordingly, the repeater 110 may utilize beam A0 for subsequent UL/DL transmission with the gNB 110. The gNB 110 then transmits 215 a group of SSB signals in a plurality of periods.

The repeater 120 forwards 220 the group of SSB signals via a plurality of first beams towards respective directions. As shown in FIG. 3, the group of SSB signals is transmitted towards circular directions of the plurality of first beams, and a first beam for transmitting the SSB signals is changed per period. In the context of the process 200, the term “first beam” refers to the beams available for communication with the UE 130.

In some example embodiments, the period is same as the periodicity of SSB signals.

In some example embodiments, the circular directions of the first beams are associated with SFN and the periodicity of SSB. That is, the beam direction of the Tx beam for DL transmission with the UE 130 is changed per fixed time unit. As shown in FIG. 3, for SFN=n+M, the repeater 120 forwards the SSB signals via the first beam A1, for SFN=n+2M, the repeater 120 forwards the SSB signals via the first beam A2, for SFN=n+3M, the repeater 120 forwards the SSB signals via the first beam A3, and for SFN=n+4M, the repeater 120 forwards the SSB signals via the first beam A4.

As such, the beam direction of the first beam is changed per periodicity, while the beam direction of the first beam remains unchanged in each period. A corresponding relationship between beam indexes of the first beams and period numbers (e.g., the SFN) of the plurality of periods may be predefined at the gNB 110 and the repeater 120.

In some example embodiments, a timer for beam switching may be configured to the repeater 120 for deciding when to change the beam direction. The counting value for the timer may be preconfigured by the gNB 110. For example, the gNB 110 may indicate a configuration of the timer via RRC signaling.

By way of example, if the timer is still running, the repeater 120 may determine to utilize the current first beam for transmitting the SSB signals. Otherwise, if the timer is expired, the repeater 120 may change from the current first beam to a next first beam, and restart the timer.

The UE 130 performs 225 the blind detection for SSB signals. As a result, the UE 130 may realize time and frequency synchronization with the gNB 110 based on the detected SSB signals.

The UE 130 determines 230 PRACH resources for initial random access based on the detected SSB signal, the SFN of the detected SSB signal and measurement. The association of the PRACH and period numbers of the plurality of periods is predefined at the gNB 110 and the UE 130. By way of example, PRACH resources located from SFN=n+M+1+KM to SFN=n+M+2M+KM maybe associated with the SSB signals transmitted from SFN=n+M+KM, where K represents the number of first beams or Tx beams or different Tx beam directions of the repeater 120 for DL transmission, and K can be reported by the repeater 120 as a capability parameter.

In some example embodiments, the UE 130 may measure the received signal power of the SSB signals, and determine the PRACH resource for the random access signal based on the measurement result, which will be described in details in connection with FIGS. 4A and 4B.

As shown in FIGS. 4A-4B, the measurements 411 to 414, 421 to 424, 431 to 434 and 441 to 444, which are the received signal power, are measured on the SSB signals transmitted in respective system frames with respective SFNs. As can be seen that the measurements 412, 422, 432 and 442 exceed a predefined threshold, it indicates that corresponding directions from which the SSB signals are transmitted may be better for the communications. Hence, the UE 130 may select one of PRACH resources that are associated with the SFNs corresponding to the measurements 412, 422, 432 and 442.

In some example embodiments, the first one of the measurements that exceed the predefined threshold is used for determining the PRACH resource for the initial access procedure. In this case, the UE 130 may determine the PRACH resource associated with the measurement 412 for initial access procedure.

Alternatively, in some other example embodiments, the largest one of the measurements that exceed the predefined threshold is used for determining the PRACH resource for the initial access procedure. In this case, the UE 130 may determine the PRACH resource associated with the measurement 422 for the initial access procedure. In this case, the SFN associated with the first one of the SSBs signal whose measurements exceed the predefined threshold is used for determining the PRACH resource.

Additionally or alternatively, in the above case, a time window may be introduced for finding the SSB signal with the largest received power in a sense, which helps reduce the delay of initial access. In particular, a time window may be defined for determining the largest received signal power. In other words, the UE 130 determines the largest received signal power measured during the time window. In this way, the initial access procedure will be accelerated.

The threshold as well as a length and starting point of the timer window may be configured by the network, or alternatively, specified in relevant standards. Alternatively, as shown in FIG. 4B, a start point of the time window may be determined to be the time of the first received signal whose received power (e.g., the measurement 412) is larger than the predefined threshold.

After determining the PRACH resource, the UE 130 transmits 235 the random access signal on the determined PRACH resource. The repeater 120 then forwards 240 the received random access signal via the determined Tx beam for UL transmission with the gNB 110.

The gNB 110 may utilize the same beam direction with the received beam direction of the repeater 120 DL transmission. Upon receipt of the random access signal, the gNB 110 determines 245 at least one target beam from the plurality of first beams based on the PRACH resource that carry the random access signal. The at least one target beam may be considered to be the best or optimal beams of the repeater 120 for communication with the UE 130.

In particular, the gNB 110 may determine the period number associated with the PRACH resource based on the association of the PRACH resources and the plurality of periods. The gNB 110 may then determine the target beam corresponding to the period number based on the corresponding relationship between the beam indexes and the period numbers.

Additionally or alternatively, the target beam may include the Tx beam for DL transmission from the repeater 120 to the UE 130, and/or the Rx beam for UL transmission from the UE 130 to the repeater 120.

The gNB 110 transmits 250 beam information to the repeater 120, and the beam information indicates the at least one target beam. The beam information may include, but not limited to, a beam index of the Tx beam for DL transmission with the UE 130, a beam index of the Rx beam for UL transmission with the UE 130, a period number (e.g., SFN) of the period associated with the PRACH resource carrying the random access signal, and so on.

Upon receipt of the beam information, the repeater 120 may then communicate 255 with the UE 130 via the target beams indicated by the beam information.

According to embodiments of the present disclosure, there is provided an enhanced beam pair determination scheme for repeater. In the enhanced scheme, the PRACH resources are associated with SFNs. As such, the gNB is capable of determining optimal Tx/Rx beam of the repeater for communication with the UE based on the PRACH resource that carries the random access signal from the UE.

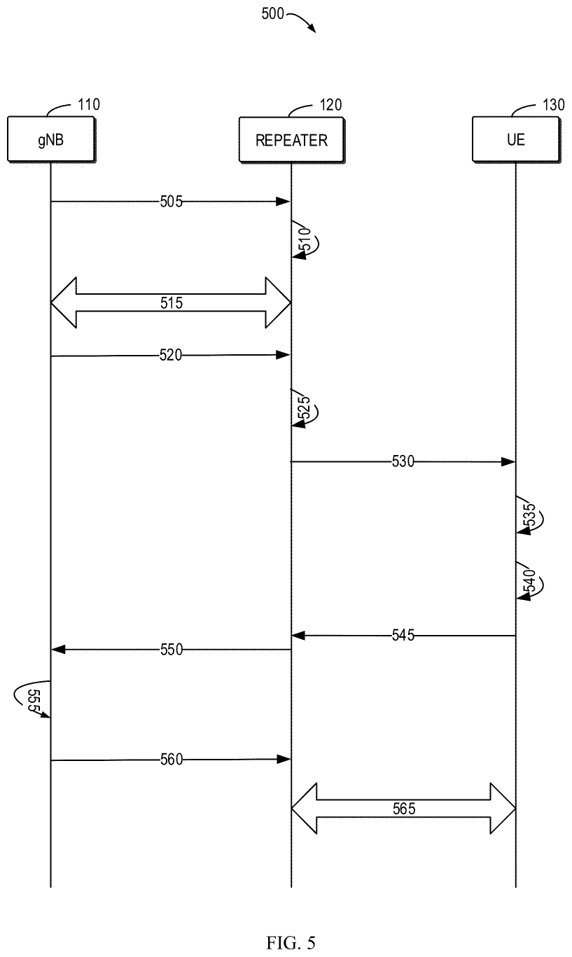

The procedure of beam determination of the repeater can be further improved in terms of efficiency according to the example embodiments, which will be described in connection with FIG. 5. FIG. 5 illustrates a signaling flow for a communication process 500 among the gNB 110, the repeater 120, and the UE 130 according to some example embodiments of the present disclosure. Only for the purpose of discussion, the process 500 will be described with reference to FIG. 1.

In the process 500, the gNB 110 initially transmits 505 SSB signals with a periodicity. Similarly to process 200, the periodicity may be indicated by the gNB 100. Accordingly, same or similar descriptions relevant to the periodicity indication are omitted to avoid repetition.

The repeater 120 performs 510 blind detection for the SSB signals, and decodes system information. Accordingly, the RRC connection is established 515 between the gNB 110 and the repeater 120.

The repeater 120 may report analog beam information to the gNB 110. The analog beam information may include, but not limited to, the beam number, beam bandwidth, beam direction of the repeater 120, and the like.

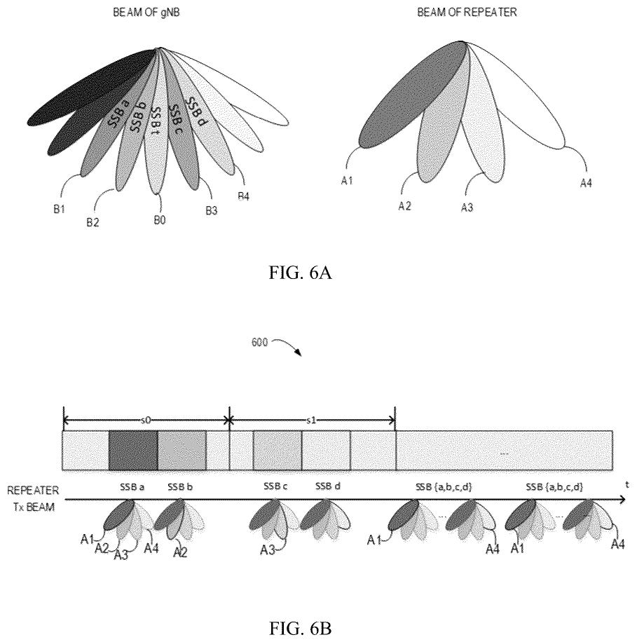

The gNB 110 may perform beam management based on the analog beam information to find a best Rx beam of the repeater 120 for DL transmission and the Tx beam for UL transmission for the communication with gNB 110. Furthermore, the gNB 110 determines one of its beams available for communication with the repeater 120 to be a target Tx beam. As shown in FIG. 6A, the beam B0 is determined to be the target Tx beam of the gNB 110 for DL transmission.

The gNB 110 transmits 520 a group of SSB signals, indexed by SSB {a, b, c, d} via the target TX beam B0. As shown in FIG. 6A, the SSB signals indexed by SSB {a, b, c, d} are associated with beams B1 to B4 respectively.

In some example embodiments, the index number of the group of SSB signals may be the same as the beam number of the repeater 120. As shown in the example of FIG. 6A, the index number of the group of SSB signals (e.g., SSB a to SSB d) is 4, which is the same as the beam number of the repeater 120.

In some example embodiments, the SSB signals indexed by SSB {a, b, c, d} may be transmitted in a channel (e.g., physical downlink shared channel or PDSCH) other than a broadcast channel, or a SSB block resource. The broadcast channel may be, such as, PBCH.

PRACH resources for initial access are associated with SSB signals. In particular, PRACH resources associated with the SSB signals indexed by SSB {a, b, c, d} are same as the PRACH resource for SSB t that is associated with beam B0. In addition, preambles to be carried on the PRACH resources associated with SSB {a, b, c, d} are different from the preamble for SSB t associated with beam B0.

If the index number of the SSB signals is less than the beam number of the repeater 120, then the SSB signals associated with the PRACH resource which have the same time resources, but different frequency resources with that corresponding to beam B0 can be included in the plurality of SSB signals.

The repeater 120 stores 525 the SSB signals associated with same PRACH resources corresponding to the SSB index (i.e., SSB t) that is associated with the target Tx beam B0. In this case, the repeater 120 may include a storage device for storing such SSB signals.

The repeater 120 transmits 530 the stored SSB signals indexed by SSB {a, b, c, d} with a beam sweeping method. FIG. 6B illustrates an example SSB transmission scheme according to some embodiments of the present disclosure. As shown in FIG. 6B, the repeater 120 transmits the stored SSB signals indexed by SSB {a, b, c, d} via beams A1 to A4 in the beam sweeping manner.

The SSB signals indexed by SSB {a, b, c, d} are transmitted by the repeater 120 in an alignment way with the transmission of normal SSB signals on the broadcast channel or the SSB block resource. The normal SSB signals are transmitted periodically by the gNB 110 for blind detection or beam management. Hence, the repeater 120 may be capable of regenerating the SSB signals corresponding to the SSB signals indexed by SSB {a, b, c, d} and received from the gNB 110.

The gNB 110 may transmit the SSB signals indexed by SSB {a, b, c, d} based on a first transmission timing. The first transmission timing may be, for example, indicated by the gNB 110 via side control channel. By way of another example, the gNB 110 may indicate SSB information that includes at least the first transmission timing via RRC signaling, or alternatively, via SIB. It should be understood that any other suitable message or signaling is applicable of indicating the SSB information or transmission timing of the SSB signal, and thus the present disclosure is not limited in this regard.

In some example embodiments, the repeater 120 may determine a second transmission timing for transmitting the SSB signals based on the first transmission timing for transmitting the normal SSB signals on the broadcast channel or the SSB block resource. The first transmission timing is aligned with the second transmission timing. The repeater 120 may then transmits the stored SSB signals to the UE 130 based on the second transmission timing.

The UE 130 performs 535 blind detection for the SSB signals, and measures received signal power. Accordingly, the UE 130 determines the PRACH resource for the initial access procedure based on the measurement result. The determination of the PRACH resource based on measurements of the SSB signals may be the same or similar to that in process 200. For simplicity of descriptions, similar operations are not repeated.

Since the detected SSB signals indexed by SSB {a, b, c, d} are associated with the same resource, i.e., the PRACH resource for SSB t, it is to be used for the initial access, to make sure the signal carrier on PRACH resource can be received by gNB via beam B0. On the other hand, the preamble carried on the PRACH resource is different and dependent on the SSB index of SSB {a, b, c, d}.

Accordingly, the UE 130 generates 540 the random access signal with the preamble associated with one of the group of SSB signals that is determined based on the measurement result. Then, the UE 130 transmits 545 the random access signal on the PRACH resource.

Upon receipt of the random access signal, the repeater 550 forwards the received random access signal to the gNB 110 via the Tx beam for UL transmission that is associated with beam B0.

Upon receipt of the random access signal via beam B0, the gNB 110 determines 555 at least one target beam of the repeater 120 for communication with the UE 130 based on the preamble carried on the PRACH resource. The target beam may include, for example, the first beam or Tx beam of repeater 120 for DL transmission with the UE 130, and the Rx beam of repeater 120 for UL transmission with the UE 130.

The gNB 110 transmits 560 beam information to the repeater 120, and the beam information indicates the at least one target beam of repeater 120. Accordingly, the repeater 120 communicates 565 with the UE 130 via the Tx beam and the Rx beam based on the beam information.

According to the example embodiments, there is provided an enhanced beam determination scheme for the repeater. In the enhanced scheme, the PRACH resources are associated with SSB signals. The repeater is capable of storing SSB signals from the gNB, and transmitting the SSB signals to the UE in an alignment way with the transmission of normal SSB signals on broadcast channel or SSB block resources. In this way, the determination of Tx/Rx beam of repeater for the communication with the UE can be accelerated, and the initial access procedure delay can be reduced.

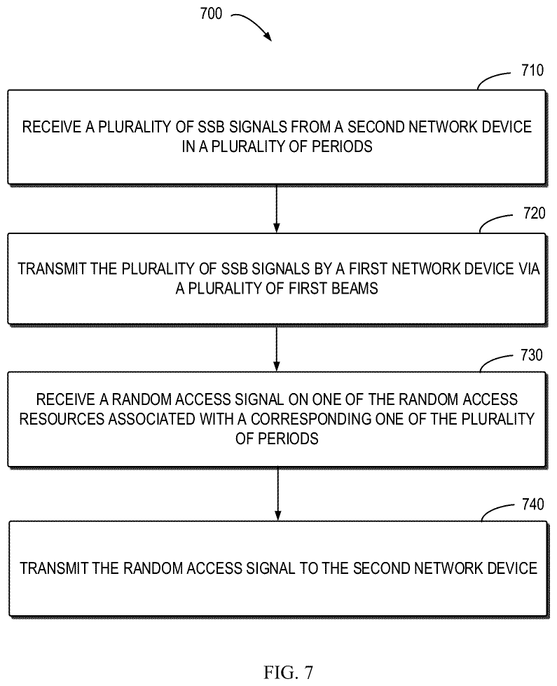

FIG. 7 shows a flowchart of an example method 700 for communication in accordance with an embodiment of the present disclosure. The method 700 can be implemented at any suitable devices. Only for the purpose of illustrations, the method 700 can be implemented at the repeater 120 as shown in FIG. 1.

At block 710, the repeater 120 receives a plurality of SSB signals from the gNB 110 in a plurality of periods. The period may be same as the periodicity of SSB signals, and may be indicated in terms of system frame.

In some example embodiments, a corresponding relationship between beam indexes of the plurality of first beams and period numbers of the plurality of periods may be predefined at the gNB 110 and the repeater 120.

The periodicity may be informed by the gNB 110. For example, the repeater 120 may receive a SIB transmitted by the gNB 110. After RRC connected with the gNB 110, the periodicity can be informed via RRC signaling. In this case, the plurality of periods may be indicated in a RRC message from the gNB 110.

Alternatively, the gNB 110 may inform the periodicity via side control channel directly. In this case, the plurality of periods may be indicated in a message received on the side control channel.

In some example embodiments, the repeater 120 may determine, from a plurality of second beams, a received beam for a DL transmission from the gNB 110 to the repeater 120 based on measurements of a plurality of SSB signals previously received from the gNB 110. The repeater 120 may then receive the plurality of SSB signals via the received beam in the plurality of periods.

At block 720, the repeater 120 transmits the plurality of SSB signals via a plurality of first beams. A first beam for transmitting the plurality of SSB signals is changed per period, and random access resources corresponding to the plurality of SSB signals are associated with the plurality of periods.

In some example embodiments, an association of the random access resources and period numbers of the plurality of periods may be predefined at the gNB 110 and the UE 130.

At 730, the repeater 120 receives, from a UE 130, a random access signal on one of the random access resources associated with a corresponding one of the plurality of periods.

At 740, the repeater 120 transmits the random access signal to the gNB 110.

In some example embodiments, the repeater 120 may receive, from the gNB 110, beam information indicative of the at least one target beam comprising at least one of a transmitted beam for downlink transmission from the repeater 120 to the UE 130 and a received beam for UL transmission from the UE 130 to the repeater 120. The repeater 120 may then communicate with the UE 130 via the transmitted beam and the received beam based on the beam information.

The repeater 120 may determine whether to change the beam direction based on a timer for SSB transmission. In some example embodiments, the repeater 120 may transmit the plurality of SSB signals via a current beam of the plurality of first beams when a timer for SSB transmission is running. If the timer is expired, the repeater 120 may change from the current beam to a next beam of the plurality of first beams, and restart the timer.

In some example embodiments, the length of timer is decided by the periodicity of SSB signals.

In some example embodiments, the repeater 120 may be a radio frequency repeater comprising a radio frequency repeater with a plurality of directional beams.

According to the example embodiments, the PRACH resources are associated with the SFNs. The repeater forwards SSB signals via the beam towards the same direction in a period, and change the beam direction per period. In this way, the PRACH resource for the initial access can be determined by taking the SFN into account, which facilitates to determine the best or optimal beam of the repeater for communication with the UE.

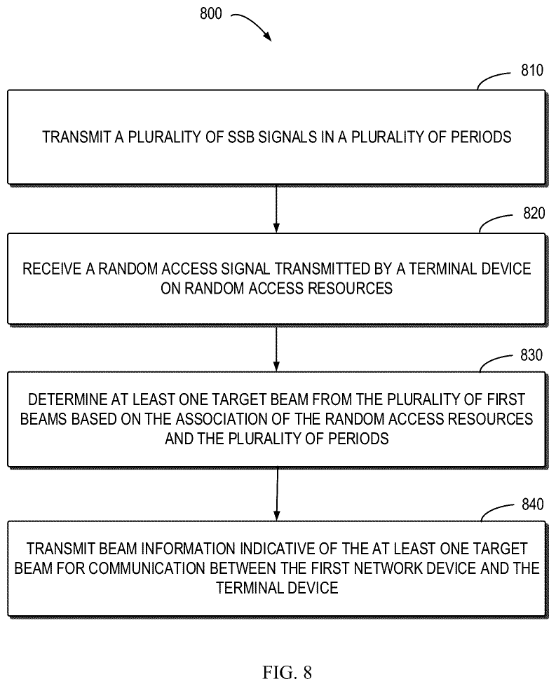

FIG. 8 shows a flowchart of an example method 800 for communication in accordance with an embodiment of the present disclosure. The method 800 can be implemented at any suitable devices. Only for the purpose of illustrations, the method 800 can be implemented at the gNB 110 as shown in FIG. 1.

At block 810, the gNB 110 transmits a plurality of SSB signals to the repeater 120 in a plurality of periods. The plurality of SSB signals is to be transmitted by the repeater 120 via a plurality of first beams. A first beam for transmitting the plurality of SSB signals is changed per period.

In some example embodiments, a corresponding relationship between beam indexes of the plurality of first beams and period numbers of the plurality of periods may be predefined at the gNB 110 and the repeater 120.

In some example embodiments, each of the plurality of periods may correspond to a running time of a timer for SSB transmission preconfigured to the repeater 120.

In some example embodiments, the gNB 110 may transmit an indication of the plurality of periods to the repeater 120. The indication may be contained in one of a RRC message, or a message transmitted on a side control channel.

At block 820, the gNB 110 receives, from the repeater 120, a random access signal transmitted by a UE 130 on random access resources. The random access resources corresponding to the plurality of SSB signals are associated with the plurality of periods.

At block 830, the gNB 110 determines at least one target beam from the plurality of first beams based on the association of the random access resources and the plurality of periods.

In some example embodiments, the gNB 110 may determine a period number associated with the random access resource, based on the association of the random access resources and the plurality of periods. The gNB 110 may then determine the at least one target beam corresponding to the period number, based on the corresponding relationship between the beam indexes and the period numbers.

In some example embodiments, the at least one target beam may comprise at least one of a transmitted beam for DL transmission from the repeater 120 to the UE 130 and a received beam for UL transmission from the UE 130 to the repeater 120.

According to the example embodiments, the repeater forwards SSB signals via the beam towards the same direction in a period, and change the beam direction per period. The base station (e.g., gNB) is capable of determining the best or optimal beam of the repeater based on the association of PRACH resources and SFNs. The determined beam information may in turns facilitate the communication between the gNB and the UE through the repeater.

At block 840, the gNB 110 transmits, to the repeater 120, beam information indicative of the at least one target beam for communication between the repeater 120 and the UE 130.

In some example embodiments, the repeater 120 may be a radio frequency repeater comprising a radio frequency repeater with a plurality of directional beams.

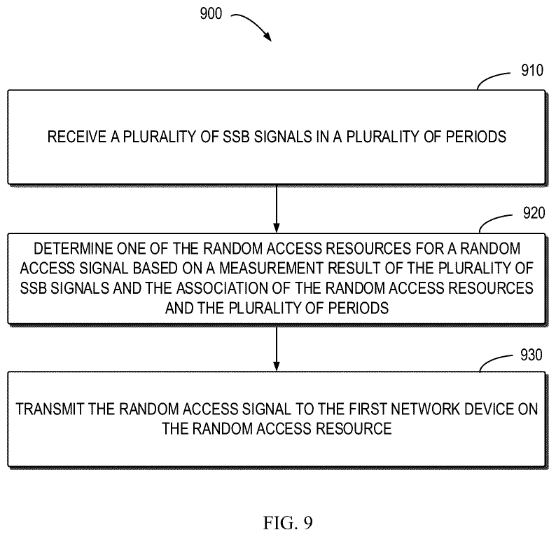

FIG. 9 shows a flowchart of an example method 900 for communication in accordance with an embodiment of the present disclosure. The method 900 can be implemented at any suitable devices. Only for the purpose of illustrations, the method 800 can be implemented at the UE 130 as shown in FIG. 1.

At block 910, the UE 130 receives a plurality of SSB signals from the repeater 120 in a plurality of periods. The plurality of SSB signals may be originally transmitted by the gNB 110, and then transmitted by the repeater 120 via a plurality of first beams. A first beam for transmitting the plurality of SSB signals is changed per period.

At block 920, the UE 130 determines one of the random access resources for a random access signal based on a measurement result of the plurality of SSB signals and the association of the random access resources and the plurality of periods.

In some example embodiments, the association of the random access resources and period numbers of the plurality of periods may be predefined at the gNB 110 and the UE 130.

In some example embodiments, the UE 130 may measure the plurality of SSB signals received in at least a part of the plurality of periods. The UE 130 may select a target SSB signal from the plurality of SSB signals based on the measurement result. The UE 130 may then determine the random access resource associated with a corresponding one of the plurality of periods in which the target SSB signal is received.

In some example embodiments, at least one of a threshold and a length of time window may be predefined or preconfigured at the UE 130 for selecting the target SSB signal.

At block 930, the UE 130 transmits the random access signal to the repeater 120 on the random access resource. The random access signal is to be transmitted by the repeater 120 to the gNB 110.

In some example embodiments, the repeater 120 may be a radio frequency repeater comprising a radio frequency repeater with a plurality of directional beams.

According to the example embodiments, the PRACH resources are associated with the SFNs. The repeater forwards SSB signals via the beam towards the same direction in a period, and change the beam direction per period. Accordingly, when determining PRACH resource for initial access, the UE can take the SFN into account, which facilitates to determine the best or optimal beam of the repeater for communication with the UE.

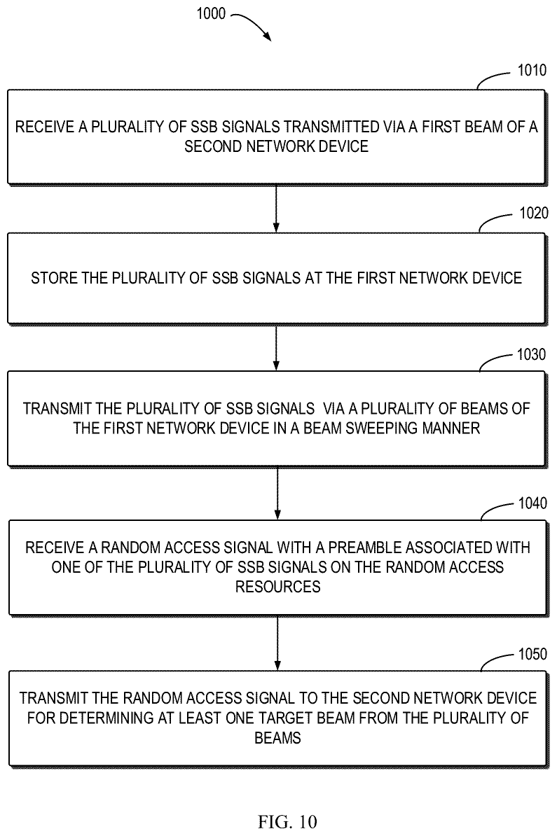

FIG. 10 shows a flowchart of an example method 1000 for communication in accordance with an embodiment of the present disclosure. The method 1000 can be implemented at any suitable devices. Only for the purpose of illustrations, the method 1000 can be implemented at the repeater 120 as shown in FIG. 1.

At block 1010, the repeater 120 receives a plurality of SSB signals transmitted via a first beam of a second network device. The plurality of SSB signals may be associated with a plurality of second beams of the gNB 110. The random access resources associated with the plurality of SSB signals are same with that corresponding to the first beam, and preambles associated with the plurality of SSB signals are different from a preamble corresponding to the first beam.

In some example embodiments, prior to receiving the plurality of SSB signals from the gNB 110, the repeater 120 may report information about the plurality of beams to the gNB 110. The information may include at least one of the beam number, beam widths, and directions of the plurality of beams.

In some example embodiments, the index number of the plurality of SSB signals may be the same as the beam number of the plurality of beams.

Alternatively, in some other embodiments, the index number of the plurality of SSB signals with same random access resources may be less than the beam number of the plurality of beams. In this case, the plurality of SSB signals includes the SSB signal associates with the random access resources correspond to same time resources but different frequency resources.

In some example embodiments, the plurality of SSB signals to be stored may be received on a channel other than a broadcast channel, or a SSB block resource. The broadcast channel may be, for example, PBCH.

At block 1020, the repeater 120 stores the plurality of SSB signals at the repeater 120. In some example embodiments, the repeater 120 includes a storage device for storing the SSB signals.

At block 1030, the repeater 120 transmits the plurality of SSB signals via a plurality of beams of the first network device in a beam sweeping manner.

In some example embodiments, the plurality of stored SSB signals may be transmitted based on second transmission timing of the repeater 120 aligned with first transmission timing for transmitting normal SSB signals on the broadcast channel, or the SSB block resource.

In some example embodiments, the repeater 120 may receive an indication of the first transmission timing from the gNB 110. The repeater 120 may then determine the second transmission timing based on the first transmission timing. In these embodiments, the indication of the first transmission timing may be contained in one of a message received on a side control channel, a RRC message, or a SIB.

At block 1040, the repeater 120 receives, from the UE 130, a random access signal with a preamble associated with one of the plurality of SSB signals on the random access resources.

At block 1050, the repeater 120 transmits the random access signal to the gNB 110 for determining at least one target beam from the plurality of beams.

In some example embodiments, the repeater 120 may receive beam information from the gNB 110, and the beam information indicates the at least one target beam comprising at least one of a transmitted beam for DL transmission from the repeater 120 to the UE 130 and a received beam for UL transmission from the UE 130 to the repeater 120. The repeater 120 may then communicate with the UE 130 via the transmitted beam and the received beam based on the beam information.

In some example embodiments, the repeater 120 may be a radio frequency repeater comprising a radio frequency repeater with a plurality of directional beams.

According to the example embodiments, the PRACH resources are associated with SSB signals, and random access signals associated with different SSB index correspond to the same PRACH resources. The repeater can store the SSB signals associated with the same PRACH resources, and forwarding the same based on a timing aligned with the gNB's timing for transmitting normal SSB signals. In this way, the procedure for determining the best or optimal beam of the repeater for communication with the UE can be facilitated and the delay of initial access procedure can be reduced.

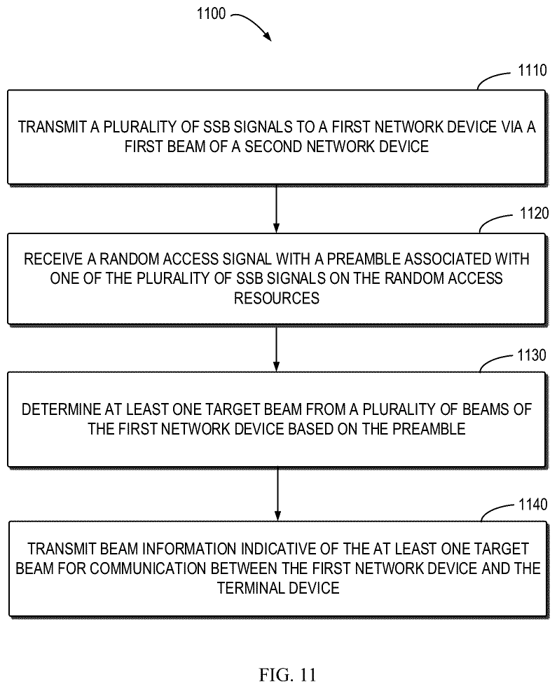

FIG. 11 shows a flowchart of an example method 1100 for communication in accordance with an embodiment of the present disclosure. The method 1100 can be implemented at any suitable devices. Only for the purpose of illustrations, the method 1100 can be implemented at the gNB 110 as shown in FIG. 1.

At block 1110, the gNB 110 transmits a plurality of SSB signals to the repeater 120 via a first beam of the gNB 110. The plurality of SSB signals may be associated with a plurality of second beams of the gNB 110. The random access resources associated with the plurality of SSB signals are same with that corresponding to the first beam, and preambles associated with the plurality of SSB signals are different from a preamble corresponding to the first beam.

In some example embodiments, the gNB 110 may receive information about the plurality of beams from the repeater 120. The information may include, but not limited to, the beam number, beam widths, directions of the plurality of beams, and so on. The gNB 110 may then determine the first beam from the plurality of beams based on the information about the plurality of beams.

In some example embodiments, the plurality of SSB signals may be transmitted on a channel other than a broadcast channel or a SSB block resource. The broadcast channel may be, for example, PBCH.

In some example embodiments, the gNB 110 may transmit an indication of first transmission timing of the gNB 110 for transmitting the plurality of SSB signals to the repeater 110 for determining second transmission information for transmitting the plurality of SSB signals by the repeater 110. The first transmission timing is aligned with the second transmission timing. In these embodiments, the indication of the first transmission timing may be contained in one of a message transmitted on a side control channel, a RRC message, or a SIB.

In some example embodiments, the index number of the plurality of SSB signals may be the same as the beam number of the plurality of beams.

In some other example embodiments, the index number of the plurality of SSB signals with same random access resources is less than the beam number of the plurality of beams, and the plurality of SSB signals includes the SSB signal associated with the random access resources corresponding to same time resources but different frequency resources.

At block 1120, the gNB 110 receives, from the repeater 120, a random access signal with a preamble associated with one of the plurality of SSB signals on the random access resources.

At block 1130, the gNB 110 determines at least one target beam from a plurality of beams of the repeater 120 based on the preamble.

At block 1140, the gNB 110 transmits beam information to the repeater 120, and the beam information indicates the at least one target beam for communication between the repeater 120 and the UE 130.

In some example embodiments, the repeater 120 may be a radio frequency repeater comprising a radio frequency repeater with a plurality of directional beams.

According to the example embodiments, the PRACH resources are associated with SSB signals, and random access signals associated with different SSB index correspond to the same PRACH resources. The gNB receives the random access signal on the same resource corresponding to the SSB index related to the best beam of the link between gNB and the repeater, and determines the best beam of repeater for communication with the UE based on the association of PRACH preamble and SSB index. In this way, the procedure for determining the best or optimal beam of the repeater for communication with the UE can be facilitated and the delay of initial access procedure can be reduced

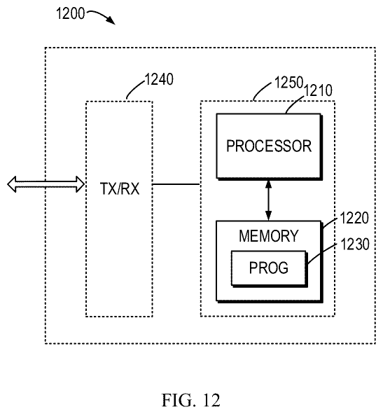

FIG. 12 is a simplified block diagram of a device 1200 that is suitable for implementing embodiments of the present disclosure. The device 1200 can be considered as a further example implementation of the gNB 110 as shown in FIG. 1. Accordingly, the device 1200 can be implemented at or as at least a part of the gNB 110. Alternatively, the device 1200 can be considered as a further example implementation of the repeater 120 as shown in FIG. 1. Accordingly, the device 1200 can be implemented at or as at least a part of the repeater 120. Alternatively, the device 1200 can be considered as a further example implementation of the UE 130 as shown in FIG. 1. Accordingly, the device 1200 can be implemented at or as at least a part of the UE 130

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1220 stores at least a part of a program 1230. The TX/RX 1240 is for bidirectional communications. The TX/RX 1240 has at least one antenna to facilitate communication, though in practice the base station, the repeater or the UE as mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the device 1200 to operate in accordance with the embodiments of the present disclosure, as discussed herein with reference to FIGS. 2 to 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In some example embodiments, a first network device comprises circuitry configured to: upon receipt of a plurality of synchronization signal/physical broadcast channel block (SSB) signals from a second network device in a plurality of periods, transmit the plurality of SSB signals via a plurality of first beams, a first beam for transmitting the plurality of SSB signals being changed per period, and random access resources corresponding to the plurality of SSB signals being associated with the plurality of periods; and transmit the random access signal to the second network device.

In some example embodiments, a corresponding relationship between beam indexes of the plurality of first beams and period numbers of the plurality of periods is predefined at the first and second network devices.

In some example embodiments, the circuitry may be further configured to: determine, from a plurality of second beams, a received beam for a downlink transmission from the second network device to the first network device based on measurements of a plurality of SSB signals previously received from the second network device; and receive the plurality of SSB signals via the received beam in the plurality of periods.

In some example embodiments, the circuitry may be further configured to: receive, from the second network device, beam information indicative of the at least one target beam comprising at least one of a transmitted beam for downlink transmission from the first network device to the terminal device and a received beam for uplink transmission from the terminal device to the first network device; and communicate with the terminal device via the transmitted beam and the received beam based on the beam information.

In some example embodiments, an association of the random access resources and period numbers of the plurality of periods is predefined at the second network device and the terminal device.

In some example embodiments, the circuitry may be configured to transmit the plurality of SSB signals by: transmitting the plurality of SSB signals via a current beam of the plurality of first beams when a timer for SSB transmission is running; and in accordance with a determination that the timer is expired, changing from the current beam to a next beam of the plurality of first beams, and restarting the timer.

In some example embodiments, the plurality of periods is indicated in a radio resource control message from the second network device or a message received on a side control channel.

In some example embodiments, the second network device comprises a base station, and a first network device comprises a radio frequency repeater comprising a radio frequency repeater with a plurality of directional beams.

In some example embodiments, a second network device comprises circuitry configured to: transmit, to a first network device, a plurality of SSB signals in a plurality of periods, the plurality of synchronization signal/physical broadcast channel block (SSB) signals to be transmitted by the second network device via a plurality of first beams towards respective directions, a first beam for transmitting the plurality of SSB signals being changed per period; receive, from the first network device, a random access signal transmitted by a terminal device on random access resources, wherein random access resources corresponding to the plurality of SSB signals are associated with the plurality of periods; determine at least one target beam from the plurality of first beams based on the association of the random access resources and the plurality of periods; and transmit, to the first network device, beam information indicative of the at least one target beam for communication between the first network device and the terminal device.

In some example embodiments, a corresponding relationship between beam indexes of the plurality of first beams and period numbers of the plurality of periods is predefined at the first and second network devices.

In some example embodiments, the circuitry may be configured to determine the at least one target beam by: determining, based on the association of the random access resources and the plurality of periods, a period number associated with the random access resource; and determining, based on the corresponding relationship between the beam indexes and the period numbers, the at least one target beam corresponding to the period number.

In some example embodiments, the at least one target beam comprises at least one of a transmitted beam for downlink transmission from the first network device to the terminal device and a received beam for uplink transmission from the terminal device to the first network device.

In some example embodiments, each of the plurality of periods corresponds to a running time of a timer for SSB transmission preconfigured to the first network device.

In some example embodiments, the circuitry may be further configured to: transmit an indication of the plurality of periods to the first network device, the indication being contained in one of a radio resource control message, or a message transmitted on a side control channel.

In some example embodiments, the first network device comprises a radio frequency repeater comprising a radio frequency repeater with a plurality of directional beams, and the second network device comprises a base station.

In some example embodiments, a terminal device comprises circuitry configured to: receive, from a first network device, a plurality of SSB signals in a plurality of periods, the plurality of synchronization signal/physical broadcast channel block (SSB) signals being originally transmitted by a second network device and then transmitted by the first network device via a plurality of first beams towards respective directions, a first beam for transmitting the plurality of SSB signals being changed per period; determine one of the random access resources for a random access signal based on a measurement result of the plurality of SSB signals and the association of the random access resources and the plurality of periods; and transmit the random access signal to the first network device on the random access resource, the random access signal to be transmitted by first network device to second network device.

In some example embodiments, the association of the random access resources and period numbers of the plurality of periods is predefined at the second network device and the terminal device.

In some example embodiments, the circuitry may be configured to determine the random access resource by: measuring the plurality of SSB signals received in at least a part of the plurality of periods; selecting a target SSB signal from the plurality of SSB signals based on the measurement result; and determining the random access resource associated with a corresponding one of the plurality of periods in which the target SSB signal is received.

In some example embodiments, at least one of a threshold and a length of time window is predefined or preconfigured at the terminal device for selecting the target SSB signal.

In some example embodiments, the first network device comprises a radio frequency repeater comprising a radio frequency repeater with a plurality of directional beams, and the second network device comprises a base station.

In some example embodiments, a first network device comprises circuitry configured to: receive a plurality of synchronization signal/physical broadcast channel block (SSB) signals transmitted via a first beam of a second network device, the plurality of SSB signals being associated with a plurality of second beams of the second network device, random access resources associated with the plurality of SSB signals corresponding to the first beam, and preambles associated with the plurality of SSB signals being different from a preamble corresponding to the first beam; store the plurality of SSB signals at the first network device; transmit the plurality of SSB signals via a plurality of beams of the first network device in a beam sweeping manner; receive, from a terminal device, a random access signal with a preamble associated with one of the plurality of SSB signals on the random access resources; and transmit the random access signal to the second network device for determining at least one target beam from the plurality of beams.

In some example embodiments, the circuitry may be further configured to: prior to receiving the plurality of SSB signals from the second network device, report, to the second network device, information about the plurality of beams, the information comprising at least one of the beam number, beam widths, and directions of the plurality of beams.

In some example embodiments, the plurality of SSB signals is received on a channel other than a broadcast channel or a SSB block resource.

In some example embodiments, the plurality of SSB signals is transmitted based on second transmission timing of the first network device aligned with first transmission timing for transmitting normal SSB signals by the second network device on the broadcast channel or the SSB block resource.

In some example embodiments, the circuitry may be further configured to: receive, from the second network device, an indication of the first transmission timing; and determine the second transmission timing based on the first transmission timing.

In some example embodiments, the indication of the first transmission timing is contained in one of a message received on a side control channel, a radio resource control message, or a system information block.

In some example embodiments, the index number of the plurality of SSB signals is the same as the beam number of the plurality of beams.

In some example embodiments, the index number of the plurality of SSB signals with same random access resources is less than the beam number of the plurality of beams, the plurality of SSB signals includes the SSB signal associated with the random access resources corresponding to same time resources but different frequency resources.

In some example embodiments, the circuitry may be further configured to: receive, from the second network device, beam information indicative of the at least one target beam comprising at least one of a transmitted beam for downlink transmission from the first network device to the terminal device and a received beam for uplink transmission from the terminal device to the first network device; and communicate with the terminal device via the transmitted beam and the received beam based on the beam information.

In some example embodiments, the first network device comprises a radio frequency repeater comprising a radio frequency repeater with a plurality of directional beams, and the second network device comprises a base station.

In some example embodiments, a second network device comprises circuitry configured to: transmit, to a first network device, a plurality of synchronization signal/physical broadcast channel block (SSB) signals via a first beam of a second network device, the group of SSB signals being associated with a plurality of second beams of the second network device, random access resources associated with the plurality of SSB signals corresponding to the first beam, and preambles associated with the plurality of SSB signals being different from a preamble corresponding to the first beam; receive, from the first network device, a random access signal with a preamble associated with one of the plurality of SSB signals on the random access resources; determine at least one target beam from a plurality of beams of the first network device based on the preamble; and transmit, to the first network device, beam information indicative of the at least one target beam for communication between the first network device and the terminal device.

In some example embodiments, the circuitry may be further configured to: receive, from the first network device, information about the plurality of beams, the information comprising at least one of the beam number, beam widths, and directions of the plurality of beams; and determine the first beam from the plurality of beams based on the information about the plurality of beams.

In some example embodiments, the plurality of SSB signals is transmitted on a channel other than a broadcast channel or a SSB block resource.

In some example embodiments, the circuitry may be further configured to: transmit an indication of first transmission timing of the second network device for transmitting the plurality of SSB signals to the first network device for determining second transmission information for transmitting the plurality of SSB signals by the first network device, the first transmission timing being different from the second transmission timing.

In some example embodiments, the indication of the first transmission timing is contained in one of a message transmitted on a side control channel, a radio resource control message, or a system information block.

In some example embodiments, the index number of the plurality of SSB signals is the same as the beam number of the plurality of beams.

In some example embodiments, the index number of the plurality of SSB signals with same random access resources is less than the beam number of the plurality of beams, the plurality of SSB signals includes the SSB signal associated with the random access resources corresponding to same time resources but different frequency resources.

In some example embodiments, the first network device comprises a radio frequency repeater comprising a radio frequency repeater with a plurality of directional beams, and the second network device comprises a base station.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2, 5 and 7 to 11. Generally, program modules include routines, programs, libraries, objects, classes, components, data structures, or the like that perform particular tasks or implement particular abstract data types. The functionality of the program modules may be combined or split between program modules as desired in various embodiments.

Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

I/We claim:

1. A method for communication, comprising:
upon receipt of a plurality of synchronization signal/physical broadcast channel block, SSB, signals from a second network device in a plurality of periods, transmitting the plurality of SSB signals by a first network device via a plurality of first beams, a first beam for transmitting the plurality of SSB signals being changed per period, and random access resources corresponding to the plurality of SSB signals being associated with the plurality of periods;
receiving, from a terminal device, a random access signal on one of the random access resources associated with a corresponding one of the plurality of periods; and
transmitting the random access signal to the second network device.

2. The method of claim 1, wherein a corresponding relationship between beam indexes of the plurality of first beams and period numbers of the plurality of periods is predefined at the first and second network devices.

3. The method of claim 1, further comprising:
determining, from a plurality of second beams, a received beam for a downlink transmission from the second network device to the first network device based on measurements of a plurality of SSB signals previously received from the second network device; and
receiving the plurality of SSB signals via the received beam in the plurality of periods.

4. The method of claim 1, further comprising:
receiving, from the second network device, beam information indicative of the at least one target beam comprising at least one of a transmitted beam for downlink transmission from the first network device to the terminal device and a received beam for uplink transmission from the terminal device to the first network device; and
communicating with the terminal device via the transmitted beam and the received beam based on the beam information.

5. The method of claim 1, wherein an association of the random access resources and period numbers of the plurality of periods is predefined at the second network device and the terminal device.

6. The method of claim 1, wherein transmitting the plurality of SSB signals comprises:
transmitting the plurality of SSB signals via a current beam of the plurality of first beams when a timer for SSB transmission is running; and
in accordance with a determination that the timer is expired, changing from the current beam to a next beam of the plurality of first beams, and restarting the timer.

7. The method of claim 1, wherein the plurality of periods is indicated in a radio resource control message from the second network device or a message received on a side control channel.

8. The method of claim 1, wherein the second network device comprises a base station, and a first network device comprises a radio frequency repeater comprising a radio frequency repeater with a plurality of directional beams.

9. A method for communication, comprising:
transmitting, at a second network device and to a first network device, a plurality of SSB signals in a plurality of periods, the plurality of synchronization signal/physical broadcast channel block, SSB, signals to be transmitted by the second network device via a plurality of first beams towards respective directions, a first beam for transmitting the plurality of SSB signals being changed per period;
receiving, from the first network device, a random access signal transmitted by a terminal device on random access resources, wherein random access resources corresponding to the plurality of SSB signals are associated with the plurality of periods;
determining at least one target beam from the plurality of first beams based on the association of the random access resources and the plurality of periods; and
transmitting, to the first network device, beam information indicative of the at least one target beam for communication between the first network device and the terminal device.

10. The method of claim 9, wherein a corresponding relationship between beam indexes of the plurality of first beams and period numbers of the plurality of periods is predefined at the first and second network devices.

11. The method of claim 10, wherein determining the at least one target beam comprises:
determining, based on the association of the random access resources and the plurality of periods, a period number associated with the random access resource; and
determining, based on the corresponding relationship between the beam indexes and the period numbers, the at least one target beam corresponding to the period number.

12. The method of claim 9, wherein the at least one target beam comprises at least one of a transmitted beam for downlink transmission from the first network device to the terminal device and a received beam for uplink transmission from the terminal device to the first network device.

13. The method of claim 9, wherein each of the plurality of periods corresponds to a running time of a timer for SSB transmission preconfigured to the first network device.

14. The method of claim 9, further comprising:
transmitting an indication of the plurality of periods to the first network device, the indication being contained in one of a radio resource control message, or a message transmitted on a side control channel.

15. The method of claim 9, wherein the first network device comprises a radio frequency repeater comprising a radio frequency repeater with a plurality of directional beams, and the second network device comprises a base station.

16. A method for communication, comprising:
receiving, at a terminal device and from a first network device, a plurality of SSB signals in a plurality of periods, the plurality of synchronization signal/physical broadcast channel block, SSB, signals being originally transmitted by a second network device and then transmitted by the first network device via a plurality of first beams towards respective directions, a first beam for transmitting the plurality of SSB signals being changed per period;
determining one of the random access resources for a random access signal based on a measurement result of the plurality of SSB signals and the association of the random access resources and the plurality of periods; and
transmitting the random access signal to the first network device on the random access resource, the random access signal to be transmitted by first network device to second network device.

17. The method of claim 16, wherein the association of the random access resources and period numbers of the plurality of periods is predefined at the second network device and the terminal device.

18. The method of claim 17, wherein determining the random access resource comprises:
measuring the plurality of SSB signals received in at least a part of the plurality of periods;
selecting a target SSB signal from the plurality of SSB signals based on the measurement result; and
determining the random access resource associated with a corresponding one of the plurality of periods in which the target SSB signal is received.

19. The method of claim 18, wherein at least one of a threshold and a length of time window is predefined or preconfigured at the terminal device for selecting the target SSB signal.

20. The method of claim 16, wherein the first network device comprises a radio frequency repeater comprising a radio frequency repeater with a plurality of directional beams, and the second network device comprises a base station.

21. A method for communication, comprising:
receiving, at a first network device, a plurality of synchronization signal/physical broadcast channel block, SSB, signals transmitted via a first beam of a second network device, the plurality of SSB signals being associated with a plurality of second beams of the second network device, random access resources associated with the plurality of SSB signals corresponding to the first beam, and preambles associated with the plurality of SSB signals being different from a preamble corresponding to the first beam;
storing the plurality of SSB signals at the first network device;
transmitting the plurality of SSB signals via a plurality of beams of the first network device in a beam sweeping manner;
receiving, from a terminal device, a random access signal with a preamble associated with one of the plurality of SSB signals on the random access resources; and
transmitting the random access signal to the second network device for determining at least one target beam from the plurality of beams.

22. The method of claim 21, wherein the method further comprises:
prior to receiving the plurality of SSB signals from the second network device, reporting, to the second network device, information about the plurality of beams, the information comprising at least one of the beam number, beam widths, and directions of the plurality of beams.

23. The method of claim 21, wherein the plurality of SSB signals are received on a channel other than a broadcast channel or a SSB block resource.

24. The method of claim 23, wherein the plurality of SSB signals is transmitted based on second transmission timing of the first network device aligned with first transmission timing for transmitting normal SSB signals by the second network device on the broadcast channel or the SSB block resource.

25. The method of claim 24, further comprising:
receiving, from the second network device, an indication of the first transmission timing; and
determining the second transmission timing based on the first transmission timing.

26. The method of claim 25, wherein the indication of the first transmission timing is contained in one of a message received on a side control channel, a radio resource control message, or a system information block.

27. The method of claim 21, wherein the index number of the plurality of SSB signals is the same as the beam number of the plurality of beams.

28. The method of claim 21, wherein the index number of the plurality of SSB signals with same random access resources is less than the beam number of the plurality of beams, the plurality of SSB signals includes the SSB signal associated with the random access resources corresponding to same time resources but different frequency resources.

29. The method of claim 21, further comprising:
receiving, from the second network device, beam information indicative of the at least one target beam comprising at least one of a transmitted beam for downlink transmission from the first network device to the terminal device and a received beam for uplink transmission from the terminal device to the first network device; and
communicating with the terminal device via the transmitted beam and the received beam based on the beam information.

30. The method of claim 21, wherein the first network device comprises a radio frequency repeater comprising a radio frequency repeater with a plurality of directional beams, and the second network device comprises a base station.

31. A method for communication, comprising:
transmitting, at a second network device and to a first network device, a plurality of synchronization signal/physical broadcast channel block, SSB, signals via a first beam of a second network device, the group of SSB signals being associated with a plurality of second beams of the second network device, random access resources associated with the plurality of SSB signals corresponding to the first beam, and preambles associated with the plurality of SSB signals being different from a preamble corresponding to the first beam;
receiving, from the first network device, a random access signal with a preamble associated with one of the plurality of SSB signals on the random access resources;
determining at least one target beam from a plurality of beams of the first network device based on the preamble; and
transmitting, to the first network device, beam information indicative of the at least one target beam for communication between the first network device and the terminal device.

32. The method of claim 31, wherein the method further comprises:
receiving, from the first network device, information about the plurality of beams, the information comprising at least one of the beam number, beam widths, and directions of the plurality of beams; and
determining the first beam from the plurality of beams based on the information about the plurality of beams.

33. The method of claim 31, wherein the plurality of SSB signals is transmitted on a channel other than a broadcast channel or a SSB block resource.

34. The method of claim 31, further comprising:
transmitting an indication of first transmission timing of the second network device for transmitting the plurality of SSB signals to the first network device for determining second transmission information for transmitting the plurality of SSB signals by the first network device, the first transmission timing being different from the second transmission timing.

35. The method of claim 34, wherein the indication of the first transmission timing is contained in one of a message transmitted on a side control channel, a radio resource control message, or a system information block.

36. The method of claim 31, wherein the index number of the plurality of SSB signals is the same as the beam number of the plurality of beams.

37. The method of claim 31, wherein the index number of the plurality of SSB signals with same random access resources is less than the beam number of the plurality of beams, the plurality of SSB signals includes the SSB signal associated with the random access resources corresponding to same time resources but different frequency resources.

38. The method of claim 31, wherein the first network device comprises a radio frequency repeater comprising a radio frequency repeater with a plurality of directional beams, and the second network device comprises a base station.

39. A first network device comprising:
a processor; and
a memory coupled to the processor and storing instructions thereon, the instructions, when executed by the processor, causing the terminal device to perform the method according to any of claims 1-8 and 21-30.

40. A second network device comprising:
a processor; and
a memory coupled to the processor and storing instructions thereon, the instructions, when executed by the processor, causing the terminal device to perform the method according to any of claims 9-15 and 31-38.

41. A terminal device comprising:
a processor; and
a memory coupled to the processor and storing instructions thereon, the instructions, when executed by the processor, causing the terminal device to perform the method according to any of claims 16-20.
